(19) United States
(12) Patent Application Publication
(10) Pub. No.: US 2021/0324243 A1
(43) Pub. Date: Oct. 21, 2021

(54) TAPES AND METHODS OF USE FOR MASKING ALUMINUM SURFACES IN ACID ANODIZATION

(71) Applicant: 3M INNOVATIVE PROPERTIES COMPANY, St. Paul, CA (US)

(72) Inventors: Christopher W. Cox, Hugo, MN (US); Sarang V. Deodhar, Waconia, MN (US); Albert I. Everaerts, Tucson, AZ (US); Becky A. Jetto, Jordan, MN (US); James J. Kobe, Newport, MN (US); Meredith A. Opatz, Hudson, WI (US); Carla S. Thomas, Woodbury, MN (US)

(21) Appl. No.: 17/252,599

(22) PCT Filed: Jun. 27, 2019
(86) PCT No.: PCT/IB2019/055450

§ 371 Date: Dec. 15, 2020

Related U.S. Application Data
(60) Provisional application No. 62/691,886, filed on Jun. 29, 2018.

(51) Int. Cl. C09J 7/38; C09J 7/25; C25D 11/02; C25D 11/04

(52) U.S. Cl. CPC C09J 7/385; C09J 7/255; C25D 11/022; C25D 11/04; C09J 2467/006; C09J 2301/302; C09J 2400/166; C09J 2433/00; C09J 2203/37

(57) ABSTRACT

A tape includes: a flexible backing layer having two major surfaces, wherein the backing layer has a thickness of greater than 25 micrometers; and an acrylic-based pressure sensitive adhesive layer disposed on one major surface of the backing layer, wherein the acrylic-based pressure sensitive adhesive comprises the reaction of one or more (C8-C20)alkyl acrylates with one or more reinforcing monomers having a homopolymer Tg of at least 50° C., wherein the acrylic-based pressure sensitive adhesive has a tan δ of at least 0.5 measured at 80° C. and an oscillating frequency of 1 radian/second, and wherein the acrylic-based pressure sensitive adhesive layer has a thickness of at least 5 micrometers; wherein, when disposed on an aluminum substrate, the tape displays clean removal from the aluminum substrate according to the Clean Removal Test described in the Examples Section, and a leakage distance of less than 762 micrometers according to the Chromic Acid Anodization-Leakage Distance Test described in the Examples Section. A method of anodizing an aluminum surface includes: providing a substrate having an aluminum surface; applying a tape as described herein to mask the aluminum surface and form a masked substrate; and exposing the masked substrate to an electrolyte solution including chromic acid under conditions effective to form aluminum oxide.

### BACKGROUND

Aluminum anodization is widely used in aerospace, electronics and general metal working industry, to improve corrosion and scratch resistance, paint and adhesive bonding on a variety of aluminum alloys, and to obtain decorative finishes on aluminum surfaces. Anodization is an electrochemical process that converts an aluminum surface to aluminum oxide. Anodization is typically carried out by dipping aluminum parts in an electrolyte bath and applying DC voltage to produce an aluminum oxide layer on the surface of the part over time. Commonly used electrolyte baths for aerospace, military, and metal finishing include chromic acid, sulfuric acid, phosphoric acid, or boric-sulfuric acid. Choice of electrolyte, applied voltage, and process time depends upon target anodic coating weight, density of coating, and desired corrosion resistance.

Chromic acid anodization (CAA) is the one of the oldest and most widely used processes in the aerospace and metal finishing industries. Typically, 40 volts (V) (Type I) or 22 V (Type IB) are used in the process, although the Type I process (40 V) is the more commonly used.

Generally, during aluminum anodization of a part, some areas of the part need to be masked to prevent anodizing. These areas depend upon the end use of the part. Currently, tapes or curable liquids and lacquers are used as maskants. Current pressure sensitive adhesive tapes that include a variety of backings and adhesive types do not meet customer's need for effective masking in CAA. Most of the tapes either fall off or show very high acid leakage distance of the CAA material under the edges of the tape (e.g., greater than 0.050 inch (i.e., 1270 micrometers)) when applied on solvent-wiped or “Alk-Deox” pretreated (a commonly used cleaning process) aluminum parts.

Liquid masking is the most effective existing solution for masking a part in a CAA process. Liquid maskants show satisfactory performance showing little leakage distance (e.g., less than 0.015 inches (i.e., 381 micrometers)), depending upon the aluminum alloy. The application process of liquid maskants is lengthy (requiring up to 24 hours curing time before anodization) and messy, which can result in smearing of adjacent areas. For example, the removal of liquid maskants typically requires the use of methyl ethyl ketone. Also, the process of applying a liquid maskant versus a tape maskant is more expensive, for example, because a masking tape may be required prior to applying the liquid maskant to assist with painting a clean straight edge, and a more skilled worker would be required. Also, additional personal protection equipment may be required. These factors make the use of liquid maskants relatively expensive and less desirable compared to the use of a masking tape.

Some silicone-based pressure sensitive adhesive tapes have been used successfully to mask parts in other anodization processes using sulfuric acid, phosphoric acid, or boric-sulfuric acid electrolyte baths. Unfortunately, these silicone-based pressure sensitive adhesives may leave an undesirable invisible residue on the surface, which is difficult to remove and can effect subsequent bonding and painting processes. This is driving the market to eliminate using these silicone-based pressure sensitive adhesive tapes.

Thus, there is a need for other adhesive tapes that will give good masking performance with low (e.g., less than 0.030 inch (762 micrometers) leakage distance on a wide variety of aluminum alloys that are anodized by various CAA processes (e.g., BAC 5019, Boeing Aircraft Corporation Standard), and is flexible, easy to handle (unlike lead or aluminum foil tapes), cuttable (e.g., by razor blade or die), and cleanly removable.

### SUMMARY

The present disclosure provides tapes, particularly masking tapes, and methods of using such tapes for anodizing aluminum surfaces in acid anodization (e.g., chromic acid anodization). Such masking tapes include an acrylic-based pressure sensitive adhesive.

In one aspect, a tape includes: a flexible backing layer having two major surfaces, wherein the backing layer has a thickness of greater than 25 micrometers; and an acrylic-based pressure sensitive adhesive layer disposed on one major surface of the backing layer, wherein the acrylic-based pressure sensitive adhesive comprises the reaction of one or more (C8-C20)alkyl acrylates with one or more reinforcing monomers having a homopolymer Tg of at least 50° C. (i.e., the glass transition temperature of a homopolymer of such monomer), wherein the acrylic-based pressure sensitive adhesive has a tan δ of at least 0.5 measured at 80° C. and an oscillating frequency of 1 radian/second, and wherein the acrylic-based pressure sensitive adhesive layer has a thickness of at least 5 micrometers; wherein, when disposed on an aluminum substrate, the tape displays clean removal from the aluminum substrate according to the Clean Removal Test described in the Examples Section, and a leakage distance of less than 762 micrometers according to the Chromic Acid Anodization-Leakage Distance Test described in the Examples Section.

In another aspect, a method of anodizing an aluminum surface is provided. The method includes: providing a substrate having an aluminum surface; applying a tape as described herein to mask the aluminum surface and form a masked substrate; and exposing the masked substrate to an electrolyte solution including an acid (e.g., chromic acid, sulfuric acid, phosphoric acid, boric-sulfuric acid, or mixtures thereof), particularly chromic acid, under conditions effective to form aluminum oxide.

The terms “polymer” and “polymeric material” are used interchangeably and refer to materials formed by reacting one or more monomers. These terms include homopolymers and copolymers. The polymers may be block, random, segmented, or the like.

The term “copolymer” refers to polymers containing two or more different monomeric units or segments, including terpolymers, tetrapolymers, etc.

The term “room temperature” refers to a temperature of 20° C. to 25° C.

The term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof).

The words “preferred” and “preferably” refer to embodiments of the disclosure that may afford certain benefits under certain circumstances. Other embodiments may also be preferred, however, under the same or other circumstances. Furthermore, the recitation of one or more preferred embodiments does not imply that other embodiments are not useful, and is not intended to exclude other embodiments from the scope of the disclosure.

Terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

The phrases “at least one of” and “comprises at least one of” followed by a list refers to any one of the items in the list and any combination of two or more items in the list.

The term “or” is generally employed in its usual sense including “and/or” unless the content clearly dictates otherwise.

The term “and/or” means one or all of the listed elements or a combination of any two or more of the listed elements (e.g., preventing and/or treating an affliction means preventing, treating, or both treating and preventing further afflictions).

Various sets of numerical ranges (for example, of the number of carbon atoms in a particular moiety, of the amount of a particular component, or the like) are described, and, within each set, any lower limit of a range can be paired with any upper limit of a range. Such numerical ranges also are meant to include all numbers subsumed within the range (for example, 1 to 5 includes 1, 1.5, 2, 2.75, 3, 3.80, 4, 5, and so forth).

All numbers herein are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The above Summary section is not intended to describe every embodiment or every implementation of the disclosure. The detailed description that follows more particularly describes illustrative embodiments. Throughout the detailed description, guidance is provided through lists of examples, which examples can be used in various combinations. In each instance, a recited list serves only as a representative group and should not be interpreted as being an exclusive list.

### FIGURES

FIG. 1 is a tape of the present disclosure, not necessarily to scale.

### DETAILED DESCRIPTION

The present disclosure provides tapes, particularly masking tapes, and methods of using such tapes for anodizing aluminum surfaces in acid anodization, particularly chromic acid anodization.

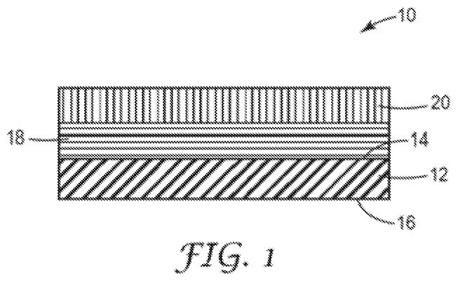

In one aspect, as shown in FIG. 1, a tape 10 includes: a flexible backing layer 12 having two major surfaces 14 and 16, wherein the backing layer 12 has a thickness of greater than 25 micrometers and up to 200 micrometers, and one major surface 14 of the backing layer 12 is an (optionally) primed and/or treated surface 18; and an acrylic-based pressure sensitive adhesive layer 20 disposed on the (optionally) primed and/or treated surface 18 of the backing layer 12, wherein the pressure sensitive adhesive layer 20 has a thickness of at least 5 micrometers.

In certain embodiments, the backing thickness and adhesive thickness, and the relationship between the two are important factors to balance and improve masking performance of the tape. That is, the proper selection of backing thickness and adhesive thickness can prevent edge lift-off of the tape from a surface (e.g., by oxygen bubbling) during acid anodization (e.g., chromic acid, sulfuric acid, phosphoric acid, boric-sulfuric acid anodization, or mixtures thereof). In certain embodiments, leakage distance performance (i.e., leakage distance of the CAA material under the edges of the tape and the resultant anodization) decreases with increasing backing thickness. In certain embodiments, however, flexibility (allowing conformability to the profile of a product to be anodized) and handling characteristics of a tape diminishes with increasing backing thickness.

A tape of the present disclosure, when disposed on an aluminum substrate, displays clean removal after the anodization process according to the Clean Removal Test described in the Examples Section. In brief, this test involves the removal by hand of a tape strip from an aluminum panel after chromic acid anodization at rate of about 12 inches/minute (30 cm/min) and an angle of about 180° from the surface.

A tape of the present disclosure, when disposed on an aluminum substrate, displays a leakage distance of less than 0.030 inch (762 micrometers) according to the Chromic Acid Anodization-Leakage Distance Test described in the Examples Section. Preferably, a tape of the present disclosure, when disposed on an aluminum substrate, displays a leakage distance of less than 0.025 inch (635 micrometers), and even more preferably less than 0.020 inch (508 micrometers) according to the Chromic Acid Anodization-Leakage Distance Test.

In certain embodiments, a tape of the present disclosure, when disposed on an aluminum substrate, displays a peel adhesion strength of less than 65 oz/in (711 N/m), less the 60 oz/in (657 N/m), less than 50 oz/in (547 N/m), less than 35 oz/in (383 N/m), less than 30 oz/in (328 N/m), less than 20 oz/in (219 N/m), or less than 10 oz/in (110 N/m), according to the Peel Adhesion Strength Test (modified ASTM D-3330/D3330M-04 (2010)). Such values are based on adhesive failure. Cohesive failure is typically unacceptable. Although generally there is no minimum adhesion value, a tape of the present disclosure, when disposed on an aluminum substrate, displays a peel adhesion of at least 2 oz/in (21.9 N/m) according to the Peel Adhesion Strength Test. The specific peel adhesion strength of a tape of the present disclosure will depend, in part, on the particular adhesive used.

A tape of the present disclosure may also be removed after acid anodization in one step with clean removal. In particular, in certain embodiments, a tape of the present disclosure may be removed without the need for additional solvent cleaning.

Because of such good performance with respect to adhesion, leakage distance, and removal, tapes of the present disclosure are particularly suited for use in anodizing an aluminum surface.

In some embodiments of the present disclosure, aluminum substrates to be masked from an acid anodizing (e.g., CAA) solution by the tape as described herein include aluminum substrates having a surface roughness average (Ra) value of from 0.382 to 0.463 micrometer (as measured using a MARSURFM-300 PROFILOMETER with probe RD 18C, available from Mahr Federal Incorporated, Providence, R.I.). Surface roughness of the aluminum substrate may negatively influence the resulting leakage values of the masking tape. Very rough substrate surfaces (e.g., an aluminum panel with an Ra value of greater than 3.175 micrometers and up to about 5.10 micrometers) may allow for entry under the tape of the acid anodization solution by way of channels at the masking tape edge due to surface roughness. These channels created by the surface roughness may not be completely sealed by the masking tape adhesive, thus yielding unacceptable leakage values, or in extreme cases, masking tape lift.

A typical method of the present disclosure includes: providing a substrate having an aluminum surface; applying a tape as described herein to mask the aluminum surface and form a masked substrate; and exposing the masked substrate to an electrolyte solution including an acid (e.g., chromic acid, sulfuric acid, phosphoric acid, boric-sulfuric acid, or mixtures thereof), particularly chromic acid, under conditions effective to form aluminum oxide. In certain embodiments, the step of exposing the masked substrate to an electrolyte solution includes immersing the masked substrate in an electrolyte bath comprising an acid (e.g., chromic acid, sulfuric acid, phosphoric acid, boric-sulfuric acid, or mixtures thereof), particularly chromic acid, under conditions effective to form aluminum oxide.

In certain embodiments, the method further includes cleaning the aluminum surface prior to applying the tape. In certain embodiments, cleaning the aluminum surface includes applying an alkaline deoxidation treatment (i.e., an “Alk-Deox” or “alkaline Deox” treatment). This treatment involves removal of an aluminum oxide layer formed on aluminum parts that result from corrosion or high temperature treatments of parts. A typical Alk-Deox treatment uses an acidic solution, such as nitric acid. This treatment etches away the surface oxide layer, leaving pure aluminum on the surface to anodize.

In certain embodiments, after cleaning and prior to applying the tape, the method further includes applying a conversion coating on the aluminum surface. This conversion coating assists with corrosion protection, adhesion promotion, and/or provides a decorative surface. A typical conversion coating includes a trivalent or hexavalent chromium (e.g., ALODINE conversion coating from Henkel Technologies).

### Backing

A tape of the present disclosure includes a flexible backing (i.e., backing layer) having two major surfaces, wherein one major surface of the backing layer may include a primed or treated surface for improved adhesive anchorage to the backing. The primed/treated (i.e., primed and/or treated) surface of the backing typically includes a treated surface or a chemical coating layer (i.e., a primer layer), or both.

If the primed/treated surface is a treated surface, it includes, for example, a corona-treated surface, a plasma-treated surface, a flame-treated surface, an etched surface (e.g., sodium etched), or the like. Corona treatment is a preferred treatment used to promote improved adhesion to the backing.

If the primed/treated surface is a primed surface, it includes a chemical coating layer. The chemical coating layer (i.e., primer layer) includes, for example, a phenolic, a polyterpene, a calcium zinc resinate, a polychloroprene, a copolymer of butadiene and acrylonitrile, or a combination thereof. In certain embodiments, the chemical coating layer includes a polychloroprene. The primer is also chosen to be resistant to the acidic anodizing bath processing conditions, so the primer does not fail (e.g., dissolve, decompose, hydrolyze) between the adhesive and the backing.

If the backing layer includes a primed (e.g., chemically primed) or treated (e.g., corona treated) surface (i.e., “primed/treated surface”), an acrylic-based pressure sensitive adhesive layer is typically disposed on the primed/treated surface of the backing layer,

Flexibility and the ability to be cut (e.g., with a razor blade) are important for use of the tapes of the present disclosure as maskants. For example, a tape should be sufficiently flexible to conform to the contours of a part to be anodized. As noted in the Examples Section, the flexibility (i.e., flexural rigidity) of a material used as a backing can be calculated using the following equation.

D=Et³/12(1−v²)

wherein D is the backing flexibility (i.e., flexural rigidity), E is the tensile or Young's Modulus of the backing, t is the backing thickness, and v is Poisson's ratio of the backing material. It is desirable to have flexibility (i.e., flexural rigidity) values of less than 0.00324 Newton-meter (N-m), less than 0.00096 N-m, less than 0.0002075 N-m, less than 0.00012 N-m, or even lower.

A typical backing layer has a thickness of greater than 25 micrometers, greater than 50 micrometers, greater than 64 micrometers, greater than 65 micrometers, greater than 66 micrometers, greater than 67 micrometer, greater than 68 micrometers, greater than 69 micrometers, greater than 70 micrometers, or greater than 75 micrometers.

In certain embodiments, the backing layer has a thickness of up to 200 micrometers, up to 190 micrometers, up to 180 micrometers, up to 170 micrometers, up to 160 micrometers, up to 150 micrometers, up to 140 micrometers, up to 130 micrometers, or up to 125 micrometers.

Suitable materials for use in the backing include polyesters (such as polyethylene terephthalate and polyethylene naphthalate), polystyrene, polyolefins (such as polyethylene, polypropylene, including, e.g., monoaxially oriented polypropylene and biaxially oriented polypropylene), polytetrafluoroethylene, polyvinylidene fluoride, polyurethane, polyimide, polyamide, polyetheretherketone, liquid-crystal polyarylate, polyether sulfide, metal foils (such as aluminum, lead, and stainless steel), polyphenylene sulfide, polycarbonate, polyvinyl chloride, and combinations thereof (e.g., mixtures, copolymers, as well as composite supports having a plurality of layers of the foregoing materials laminated). In certain embodiments, the backing includes polyethylene terephthalate.

In certain embodiments, the material of the backing includes one or more additives selected from a filler (such as silicon dioxide), a catalyst (such as antimony trioxide), a plasticizer, a pigment, and a combination thereof.

### Pressure Sensitive Adhesive

Suitable acrylic (i.e., acrylic-based) pressure sensitive adhesives (PSAs) of the tapes of the present disclosure are solvent-based or solventless pressure sensitive adhesives, including those that are bulk polymerized on the web (using for example UV or thermal processes) and hot melt coated adhesives. A suitable acrylic-based PSA not only adheres the tape to a substrate surface, but also acts as barrier against the acid anodizing solution (e.g., chromic acid), and prevents masked aluminum from oxidizing.

In some embodiments, it is preferred that the adhesives have lower electro-conductivity (or higher electro-resistivity) to prevent gas formation (resulting from the electrolytic reaction in the anodizing bath), which could lift the tape, and lower water-uptake to prevent swelling and a decrease in resistivity. Higher electro-resistivity means that the bulk (or volume) resistivity of the adhesives is generally above 1×10¹¹ ohm-cm as measured in the plane. As used herein, the plane of the adhesive is the x-y direction or that direction perpendicular to the adhesive thickness. In some embodiments, the electrical resistivity in the z- and/or x-y direction is much higher than 1×10¹¹ ohm-cm. Lower water uptake, for example, means that the adhesives, when exposed to 85% relative humidity at 85° C. for 3 days and then titrated using the Karl-Fisher technique, show a water content of less than 2 percent by weight (wt-%), ideally less than 1.5 wt-% of the adhesive.

In the methods described herein, an adhesive should be cleanly removable from the aluminum substrate after acid anodization; however, typically, acrylic adhesives are not cleanly removable from aluminum treated for an anodization process and they may be more sensitive to water than other adhesive polymers. Thus, acrylic-based pressure sensitive adhesives have not been generally used in such applications.

In addition, typical moderately crosslinked to highly crosslinked acrylic adhesives will show high leakage, and will often debond in a chromic acid anodization process. It is theorized that adhesives with too much elasticity can make sealing more difficult and lower lifting resistance. Indeed, for the adhesive to protect the aluminum panel it needs to effectively wet-out the substrate and maintain that contact throughout the anodizing process.

Adhesive elasticity can be reflected in the so-called tan delta (tan δ) value as measured using standard dynamic mechanical analysis (DMA) procedures known in the art. Tan δ is defined as the ratio of the shear loss modulus (G″) divided by the shear storage modulus (G′) at any given temperature. A higher tan δ value means that the viscous (or loss) character of the adhesive is more dominant. Likewise, a lower tan δ value means that the adhesive is more elastic (or rigid-like) in nature.

Acrylic-based pressure sensitive adhesives having a tan δ below 0.5 measured at 80° C. and an oscillating frequency of 1 radian/second are generally more prone to leakage in the Chromic Acid Anodization-Leakage Distance Test described in the Examples Section. In contrast, acrylic-based pressure sensitive adhesives having a tan δ of at least 0.5 measured at 80° C. and an oscillating frequency of 1 radian/second are generally performing well in the Chromic Acid Anodization-Leakage Distance Test described in the Examples Section. Thus, in certain embodiments, useful acrylic-based pressure sensitive adhesives have a tan δ of at least 0.5 measured at 80° C. and an oscillating frequency of 1 radian/second. In certain embodiments, useful acrylic-based pressure sensitive adhesives have a tan δ of up to 1.5, up to 1.3, or up to 1.1, measured at 80° C. and an oscillating frequency of 1 radian/second.

For the adhesives to work well, they also should be tacky at room temperature. Thus, they generally meet the Dahlquist criterion for tackiness, a criterion suggesting a shear storage modulus of 3×10e5 Pa (Pascal) or less when measured at an oscillatory frequency of 1 Hz and room temperature. Indeed, even when tested at an oscillatory frequency of 1 rad/sec (0.16 Hz) the adhesives of this disclosure meet the shear storage modulus of 3×10e5 Pa (Pascal) or less. In general, lower values allow for easier attachment of the tape to be effective. For example, adhesives having a G′ at room temperature just below the Dahlquist criterion can be applied with moderate pressure from a roller or fingers, but adhesives having a G′ on the order of 10e4 Pa can be effectively applied using even lower pressure.

The tape's effectiveness may also increase when the low angle and low rate peel resistance increases. Again, adhesives with lower elasticity will facilitate such behavior.

Suitable acrylic-based pressure sensitive adhesives are those that are cleanly removable from an aluminum substrate, after the anodization process according to the Clean Removal Test described in the Examples Section. The lack of such clean removability may result from the incorporation of too much of a comonomer that increases the adhesion to an aluminum substrate. Examples of such comonomers include acrylic acid, itaconic acid, maleic acid, maleic anhydride, beta-carboxyethylacrylate; copolymerizable sulfonic and phosphonic monomers, etc.

In certain embodiments, suitable acrylic-based pressure sensitive adhesives are lightly crosslinked to prevent the adhesive from adhesive splitting during removal. If the adhesive includes too much crosslinking, the tape may fall off during the acid anodization process. Leakage performance can be improved for a higher crosslinked adhesive with the addition of a plasticizer to soften it while still maintaining clean removal. It is a balance of adhesion and compliance of the tape to provide leakage performance and enough crosslinking to maintain cohesive strength and clean removal, but not so much so that it falls off in the acid anodization process.

While not the only determining factor, higher crosslinking density typically results in higher elasticity and a lower tan δ value when measured at elevated temperature, such as 80° C. Diluents, like plasticizers and tackifiers, typically decrease the shear storage modulus (G′) at elevated temperature and thus increase viscous behavior of the adhesive. Excessive amounts of such diluents, particularly tackifiers and/or plasticizers, can result in a loss of tackiness (due to an increase of the adhesive glass transition temperature when only tackifiers are used), loss of adhesion (due to a loss of miscibility with the polymer), or loss of cohesion (due to too low a polymer content in the adhesive).

The amount of crosslinking can be determined from the gel content of the adhesive. Typical gel contents are from 10% to 90% based on adhesive solids. At levels above 90% the crosslink density may be too high and the adhesive may become too elastic. At gel contents below 10%, the cohesive strength of the adhesive may be too low and clean removal may not be possible unless the removal peel force is low.

Typical acrylic-based PSAs can be made from reaction of one or more (C8-C20) alkyl acrylates with one or more reinforcing monomers having a homopolymer Tg of at least 50° C. (i.e., the glass transition temperature of a homopolymer of such monomer). Examples of (C8-C20)alkyl acrylates include 2-ethylhexyl acrylate (2-EHA), dodecyl acrylate isomer blend (as disclosed in U.S. Pat. No. 9,102,774 (Clapper et al.)), isooctyl acrylate, isotridecyl acrylate, isononyl acrylate, isodecyl acrylate, 2-ethylhexyl methacrylate, n-butylacrylate, 2-methyl-butylacrylate, laurylacrylate, isostearylacrylate, and mixtures thereof. Examples of reinforcing monomers include isobornyl acrylate (IBOA), acrylic acid (AA), acrylamide, N-vinyl lactams, N-alkyl acrylamides, N,N-dialkyl acrylamides, and mixtures thereof. If used, acid monomers, such as acrylic acid, are used of levels below 3 parts per hundred in the adhesive composition to allow for clean removal from the aluminum panels.

In certain embodiments, the amount (in weight) of one or more (C8-C20)alkyl acrylates used in making the acrylic-based pressure sensitive adhesive of the present disclosure is at least 70 parts of the total (i.e., 100 parts) acrylic polymer, or at least 90 parts of the total acrylic polymer. In certain embodiments, the amount (in weight) of one or more (C8-C20)alkyl acrylates used in making the acrylic-based pressure sensitive adhesive of the present disclosure is up to 95 parts of the total (i.e., 100 parts) acrylic polymer, or up to 99 parts of the total acrylic polymer.

In certain embodiments, the amount (in weight) of one or more reinforcing monomers used in making the acrylic-based pressure sensitive adhesive of the present disclosure is at least 5 parts of the total (i.e., 100 parts) acrylic polymer, or at least 1 part of the total acrylic polymer. In certain embodiments, the amount (in weight) of one or more reinforcing monomers used in making the acrylic-based pressure sensitive adhesive of the present disclosure is up to 30 parts of the total (i.e., 100 parts) acrylic polymer, or up to 10 parts of the total acrylic polymer.

In certain embodiments, the acrylic-based adhesive composition may have more than one acrylic polymer as part of the mixture.

In certain embodiments of the present disclosure, solventless acrylic-based pressure sensitive adhesives can be used. A solventless pressure sensitive adhesive is a pressure sensitive adhesive that can be bulk polymerized using no solvents, small residual trace amounts of solvents, or an amount of solvent below 2 wt-%, based on the total weight of the pressure sensitive adhesive. Solventless adhesives are sometimes generally referred to as “100% solids” adhesives, but still may contain residual trace amounts of solvent. Solventless adhesives can be bulk polymerized on a backing using thermal initiation or UV initiated, for example, or they can be hot-melt coated.

In certain embodiments, a solventless acrylic-based pressure sensitive adhesive (e.g., hot melt or UV cured) is prepared from 2-ethyl hexyl acrylate (2-EHA) and/or dodecyl acrylate isomer blend (DAIB) reacted with isobornyl acrylate monomer (IBOA), acrylamide (ACM), and/or acrylic acid (AA) reinforcing monomer. In certain embodiments. both IBOA and AA or both IBOA and ACM are included. In certain embodiments, IBOA is used in an amount of less than 10 parts per hundred parts, or less than 6 parts per hundred parts, of the adhesive. In certain embodiments, AA is used in an amount of less than 3 parts per hundred parts of the adhesive.

In certain embodiment, the solventless acrylic-based pressure sensitive adhesive can be prepared from 2-ethyl hexyl acrylate (2-EHA) and/or dodecyl acrylate isomer blend (DAIB) and subsequently blended with isobornyl acrylate polymer, (IBOA-polymer), acrylamide polymer (ACM-polymer), and/or acrylic acid polymer (AA-polymer).

In certain embodiments, two or more solventless acrylic-based pressure sensitive adhesive can be blended together, for example, a 2-EHA/AA adhesive can be blended with a DAIB/IBOA adhesive. In certain embodiments, a compatible polymer can be added to a solventless acrylic pressure sensitive adhesive.

In certain embodiments, the solventless acrylic-based pressure sensitive adhesive is prepared from a reaction mixture that includes a crosslinker, a photoinitiator, a plasticizer, chain transfer agent, tackifier, or a combination thereof.

In certain embodiments, the chain transfer agent can include, but is not limited to, carbon tetrabromide, mercaptans, or a combination thereof.

In certain embodiments of a solventless acrylic-based adhesive, the crosslinker is a photo-crosslinker or a multi-functional (meth)acrylate crosslinker. Examples of crosslinkers for a solventless acrylic-based adhesive include triazine-type crosslinker, multi-functional (meth)acrylates, multi-functional isocyanates, benzophenones, copolymerizable benzophenones, anthraquinone, and mixtures thereof. In certain embodiments, a crosslinker is used in an amount of less than 0.10 part per hundred parts of the acrylic-based adhesive. Electron-beam crosslinking or thermal crosslinking (such as by using benzoyl peroxide during the drying process) may also be used to get to get the desired ranges of a G′ value, a tan delta value, a compliance, and a gel content.

In certain embodiments of a solventless acrylic-based adhesive, examples of photoinitiators include IRGACURE 651, IRGACURE 184, IRGACURE 819, ESACURE KB1, and mixtures thereof. In certain embodiments, a photoinitiator is used in an amount of up to 2 parts by weight, preferably up to 1 part by weight of the adhesive polymer, based on the total weight of the reagents.

In certain embodiments, solventless acrylic-based adhesives can be thermally initiated, using exemplary thermal initiators such as VAZO 64 and VAZO 76 (both available from DuPont Company, Wilmington, Del.) in an amount of from about 0.1 wt-% up to 1.0 wt-%, based on the total weight of the reagents (e.g., monomers).

In certain embodiments of a solventless acrylic-based adhesive, a plasticizer may be included to soften the adhesive to prevent the tape from falling off the aluminum in the CAA bath. Examples of suitable low water soluble or insoluble plasticizers miscible in acrylic adhesives include lanolin, isopropyl myristate, adipate esters, phthalate esters, phosphate esters, and citrate esters, and mixtures thereof. In certain embodiments, a plasticizer is used in an amount of up to 10 parts, or up to 5 parts, based on one hundred parts of the acrylic-based adhesive polymer. In general, the plasticizer is used as a tool to enhance compliance and provide a range of useful concentrations.

In yet other embodiments, a solventless acrylic-based adhesive can include pigments (e.g., titanium dioxide), and stabilizers (e.g., IRGACURE 1010, IRGACURE 1076, LOWINOX TBM-6, hindered amine light stabilizers (HALS)), or a combination thereof. Pigments may be used at levels of a few parts to as high as 20 parts per one hundred parts of the adhesive mixture (i.e., polymer+additives such as tackifier/plasticizer). Stabilizers may be used at levels of 0.5 part to 5 parts per one hundred parts of the adhesive mixture (i.e., polymer+additives such as tackifier/plasticizer).

In certain embodiments, an acrylic-based pressure sensitive adhesive can be prepared in one or more organic solvents and/or coated out of one or more organic solvents. Typically, a solvent-based acrylic pressure sensitive adhesive is prepared from a solution of acrylic monomers (e.g., from 20 to 80 wt-%, based on the total weight of the reaction mixture (i.e., reagents such as monomers and solvents) and organic solvents (e.g., from 20 up to 80 wt-%, based on the total weight of the reaction mixture), and as further described below.

Exemplary organic solvents include, but are not limited to, ethyl acetate, methyl ethyl ketone, acetone. toluene, isopropyl alcohol, methanol, or a combination thereof.

In certain embodiments, a solvent-based acrylic pressure sensitive adhesive is prepared from iso octyl acrylate (IOA), polymerized with acrylamide (ACM), or acrylic acid (AA) reinforcing monomer in solvent. In certain embodiments IOA, AA and ACM are included. In certain embodiments, ACM is used in an amount of less than 8 parts per hundred parts, or less than 4 parts per hundred parts, of the adhesive. In certain embodiments, AA is used in an amount of less than 1 parts per hundred parts of the adhesive.

In certain embodiments, a solvent-based acrylic pressure sensitive adhesive can be prepared from a subsequent blend of IOA/AA solvent polymerized adhesive with IOA/ACM solvent polymerized adhesive.

In certain embodiments, a solvent-based acrylic pressure sensitive adhesive is prepared from a reaction mixture that includes a crosslinker, a tackifier, a plasticizer, pigments, stabilizers, or a combination thereof.

In certain embodiments of a solvent-based acrylic adhesive, exemplary crosslinkers include, but are not limited to, multifunctional isocyanates, multifunctional aziridines, moisture-cured silanes, benzophenone, copolymerizable benzophenones, 2,4-bis(trichloromethyl)-6-(3,4-dimethoxyphenyl)-s-triazine, and mixtures thereof. In certain embodiments, a crosslinker is used in an amount of 0.01 wt-% up to 0.5 wt-%, based on the weight of the acrylic polymer.

In certain embodiments of a solvent-based acrylic adhesive, examples of tackifiers include resin esters, polyterpenes, synthetic hydrocarbon (C5-C9) resins, and mixtures thereof. In certain embodiments, a tackifier is used in an amount of 1-40 parts per hundred parts of the acrylic polymer.

In certain embodiments of a solvent-based acrylic adhesive, a plasticizer may be included to soften the adhesive to prevent the tape from falling off the aluminum in the anodization bath. Examples of suitable low water soluble or insoluble plasticizers miscible in acrylic adhesives include mineral oil, naphthenic oil, lanolin, isopropyl myristate, adipate esters, phthalate esters, phosphate esters, and citrate esters, and mixtures thereof. In certain embodiments, a plasticizer is used in an amount of at least 1 part, and typically up to 20 parts, or up to 5 parts, based on 100 parts of the acrylic polymer. In general, the plasticizer is used as a tool to enhance compliance and provide a range of useful concentrations.

In yet other embodiments, the solvent-based acrylic adhesive can include pigments (e.g., Titanium dioxide), and stabilizers (e.g., IRGACURE 1010, IRGACURE 1076, LOWINOX TBM-6, hindered amine light stabilizers (HALS)) or combinations thereof. Pigments may be used at levels of a few parts to as high as 20 parts per one hundred parts of the adhesive mixture (i.e., polymer+additives such as tackifier/plasticizer). Stabilizers may be used at levels of 0.5 part to 5 parts per one hundred parts of the adhesive mixture (i.e., polymer+additives such as tackifier/plasticizer).

The pressure sensitive adhesive layer typically has a thickness of at least 5 micrometers, and in certain embodiments, at least 10 micrometers. In certain embodiments, the pressure sensitive adhesive layer has a thickness of up to 35 micrometers, up to 30 micrometers, up to 25 micrometers, up to 20 micrometers, or up to 15 micrometers. This is in contrast to typical coating thicknesses for pressure sensitive adhesives in a masking tape, which are 0.001 inch (25.4 micrometers) or more.

### Illustrative Embodiments

The following embodiments are intended to be illustrative of the present disclosure and not limiting.

Embodiment 1 is a tape comprising: a flexible backing layer having two major surfaces, wherein the backing layer has a thickness of greater than 25 micrometers; and an acrylic-based pressure sensitive adhesive layer disposed on one major surface of the backing layer, wherein the acrylic-based pressure sensitive adhesive comprises the reaction of one or more (C8-C20) alkyl acrylates with one or more reinforcing monomers having a homopolymer Tg of at least 50° C. (i.e., the glass transition temperature of a homopolymer of such monomer), wherein the acrylic-based pressure sensitive adhesive has a tan δ of at least 0.5 measured at 80° C. and an oscillating frequency of 1 radian/second, and wherein the pressure sensitive adhesive layer has a thickness of at least 5 micrometers; wherein, when disposed on an aluminum substrate, the tape displays clean removal from the aluminum substrate according to the Clean Removal Test described in the Examples Section, and a leakage distance of less than 762 micrometers according to the Chromic Acid Anodization-Leakage Distance Test described in the Examples Section.

Embodiment 2 is the tape of embodiment 1 wherein, when disposed on an aluminum substrate, the tape displays a peel adhesion strength of less than 65 oz/in (711 N/m), less the 60 oz/in (657 N/m), less than 50 oz/in (547 N/m), less than 35 oz/in (383 N/m), less than 30 oz/in (328 N/m), less than 20 oz/in (219 N/m), or less than 10 oz/in (110 N/m), according to the Peel Adhesion Strength Test.

Embodiment 3 is the tape of embodiment 1 or 2 wherein, when disposed on an aluminum substrate, the tape displays a leakage distance of less than 635 micrometers, or less than 508 micrometers, according to the Chromic Acid Anodization-Leakage Distance Test.

Embodiment 4 is the tape of any one of embodiments 1 through 3 wherein, when disposed on an aluminum substrate, the tape displays a peel adhesion of at least 2 oz/in (21.9 N/m) according to the Peel Adhesion Strength Test.

Embodiment 5 is the tape of any one of embodiments 1 through 4 wherein the backing has a thickness of greater than 50 micrometers, greater than 64 micrometers, greater than 65 micrometers, greater than 66 micrometers, greater than 67 micrometer, greater than 68 micrometers, greater than 69 micrometers, greater than 70 micrometers, or greater than 75 micrometers.

Embodiment 6 is the tape of any one of embodiment 1 through 5 wherein the backing has a thickness of up to 200 micrometers, up to 190 micrometers, up to 180 micrometers, up to 170 micrometers, up to 160 micrometers, up to 150 micrometers, up to 140 micrometers, up to 130 micrometers, or up to 125 micrometers.

Embodiment 7 is the tape of any one of embodiments 1 through 6 wherein the backing has a flexibility (i.e., flexural rigidity) value of less than 0.00324 Newton-meter (N-m), less than 0.00096 N-m, less than 0.0002075 N-m, less than 0.00012 N-m, or even lower.

Embodiment 8 is the tape of any one of embodiments 1 through 7 wherein the pressure sensitive adhesive layer has a thickness of at least 10 micrometers.

Embodiment 9 is the tape of any one of embodiments 1 through 8 wherein the pressure sensitive adhesive layer has a thickness of up to 35 micrometers, up to 30 micrometers, up to 25 micrometers, up to 20 micrometers, or up to 15 micrometers.

Embodiment 10 is the tape of any of embodiments 1 through 9 wherein the backing comprises a material selected from polyesters (such as polyethylene terephthalate and polyethylene naphthalate), polystyrene, polyolefins (such as polyethylene, polypropylene, including, e.g., monoaxially oriented polypropylene and biaxially oriented polypropylene), polytetrafluoroethylene, polyvinylidene fluoride, polyurethane, polyimide, polyamide, polyetheretherketone, liquid-crystal polyarylate, polyether sulfide, metal foils (such as aluminum, lead, and stainless steel), polyphenylene sulfide, polycarbonate, polyvinyl chloride, and combinations thereof (e.g., mixtures, copolymers, as well as composite supports having a plurality of layers of the foregoing materials laminated).

Embodiment 11 is the tape of embodiment 10 wherein the backing comprises polyethylene terephthalate.

Embodiment 12 is the tape of any one of embodiments 1 through 11 wherein the backing comprises one or more additives selected from a filler (such as silicon dioxide), a catalyst (such as antimony trioxide), a plasticizer, a pigment, and a combination thereof.

Embodiment 13 is the tape of any one of embodiments 1 through 12 wherein the acrylic-based pressure sensitive adhesive comprises a solvent-based acrylic pressure sensitive adhesive.

Embodiment 14 is the tape of any one of embodiments 1 through 13 wherein the acrylic-based pressure sensitive adhesive comprises a solventless acrylic pressure sensitive adhesive.

Embodiment 15 is the tape of any one of embodiments 1 through 14 wherein one major surface of the backing layer includes a primed (e.g., chemically primed) or treated (e.g., corona treated) surface (i.e., “primed/treated surface”), and the acrylic-based pressure sensitive adhesive layer is disposed on the primed/treated surface of the backing layer,

Embodiment 16 is the tape of embodiment 15 wherein the primed/treated surface of the backing comprises a treated surface or a chemical coating layer, or both.

Embodiment 17 is the tape of embodiment 16 wherein the primed/treated surface comprises a treated surface.

Embodiment 18 is the tape of embodiment 17 wherein the treated surface comprises a corona-treated surface, a plasma-treated surface, flame-treated surface, or an etched surface (e.g., sodium etched).

Embodiment 19 is the tape of any one of embodiments 15 through 18 wherein the primed/treated surface comprises a chemical coating layer.

Embodiment 20 is the tape of embodiment 19 wherein the chemical coating layer comprises a phenolic, a polyterpene, a calcium zinc resinate, a polychloroprene, a copolymer of butadiene and acrylonitrile, or a combination thereof.

Embodiment 21 is the tape of embodiment 20 wherein the chemical coating layer comprises a polychloroprene.

Embodiment 22 is the tape of any one of embodiments 1 through 21 wherein the acrylic-based pressure sensitive adhesive has a tan δ of up to 1.5, up to 1.3, or up to 1.1, measured at 80° C. and an oscillating frequency of 1 radian/second.

Embodiment 23 is the tape of any one of embodiments 1 through 22 wherein the (C8-C20)alkyl acrylate is selected from the group of 2-ethylhexyl acrylate (2-EHA), a dodecyl acrylate isomer blend, isooctyl acrylate, isotridecyl acrylate, isononyl acrylate, isodecyl acrylate,2-ethylhexyl methacrylate, n-butylacrylate, 2-methyl-butylacrylate, laurylacrylate, isostearylacrylate, and mixtures thereof.

Embodiment 24 is the tape of any one of embodiments 1 through 23 wherein the reinforcing monomer is selected from the group of isobornyl acrylate (IBOA), acrylic acid (AA), acrylamide, N-vinyl lactams, N-alkyl acrylamides, N,N-dialkyl acrylamides, and mixtures thereof.

Embodiment 25 is the tape of embodiment 24 wherein if the reinforcing monomer is an acid monomer, such as acryl acid, it is used of at a level of below 3 parts per hundred in the adhesive composition.

Embodiment 26 is the tape of any one of embodiments 1 through 25 wherein the amount of the one or more (C8-C20)alkyl acrylates used in making the acrylic-based pressure sensitive adhesive is at least 70 parts of the total acrylic polymer, or at least 90 parts of the total acrylic polymer.

Embodiment 27 is the tape of any one of embodiments 1 through 26 wherein the amount of the one or more (C8-C20)alkyl acrylates used in making the acrylic-based pressure sensitive adhesive is up to 95 parts of the total acrylic polymer, or up to 99 parts of the total acrylic polymer.

Embodiment 28 is the tape of any one of embodiments 1 through 27 wherein the amount of the one or more reinforcing monomers used in making the acrylic-based pressure sensitive adhesive is at least 5 parts of the total acrylic polymer, or at least 1 part of the total acrylic polymer.

Embodiment 29 is the tape of any one of embodiments 1 through 28 wherein the amount of the one or more reinforcing monomers used in making the acrylic-based pressure sensitive adhesive is up to 30 parts of the total acrylic polymer, or up to 10 parts of the total acrylic polymer.

Embodiment 30 is the tape of any one of embodiments 1 through 29 wherein the acrylic-based pressure sensitive adhesive is crosslinked.

Embodiment 31 is the tape of embodiment 30 wherein the acrylic-based pressure sensitive adhesive comprises a gel content of at least 10%.

Embodiment 32 is the tape of any one of embodiments 1 through 31 wherein the acrylic-based pressure sensitive adhesive comprises a gel content of up to 90%.

Embodiment 33 is the tape of any one embodiments 1 through 32 wherein water uptake of the acrylic-based pressure sensitive adhesive is less than 2 wt-%, based on the weight of the acrylic-based pressure sensitive adhesive, when exposed to 85% relative humidity at 85° C. for 3 days and tested for water content using the Karl-Fisher technique.

Embodiment 34 is a method of anodizing an aluminum surface, the method comprising: providing a substrate having an aluminum surface; applying a tape of any one of the preceding embodiments to mask the aluminum surface and form a masked substrate;

and exposing the masked substrate to an electrolyte solution comprising an acid (e.g., chromic acid, sulfuric acid, phosphoric acid, boric-sulfuric acid, or mixtures thereof), particularly chromic acid, under conditions effective to form aluminum oxide.

Embodiment 35 is the method of embodiment 34 wherein prior to applying the tape, the method further comprises cleaning the aluminum surface prior to applying the tape.

Embodiment 36 is the method of embodiment 35 wherein cleaning the aluminum surface comprises applying an alkaline deoxidation treatment.

Embodiment 37 is the method of embodiment 35 or 36 wherein after cleaning and prior to applying the tape, the method further comprises applying a conversion coating on the aluminum surface.

Embodiment 38 is the method of embodiment 37 wherein the conversion coating comprises a trivalent or hexavalent chromium.

Embodiment 39 is the method of any one of embodiments 34 through 38 wherein the step of exposing the masked substrate to an electrolyte solution comprises immersing the masked substrate in an electrolyte bath comprising chromic acid under conditions effective to form aluminum oxide.

### Examples

The following examples are given to illustrate, but not limit, the scope of this disclosure. As used herein, all parts and percentages are by weight unless otherwise specified. All commercial materials were used as obtained from the vendor. Unless otherwise specified, materials can be obtained from Sigma-Aldrich Corp. (St. Louis, Mo.).

MATERIALS

| Designation | Description |
|---|---|
| Polyester | A slightly rough-surfaced and hazy polyester film having a thickness of |
| Backing 30 | 0.003 inch (76 micrometers), available under the trade designation |
| | SKYROL SG00L 300ga POLYESTER FILM, from SKC Films, |
| | Covington, GA. |
| IOA | Isooctyl Acrylate monomer obtained from Millipore Sigma (formerly |
| | known as Sigma Aldrich), St. Louis, MO. |
| AA | Acrylic Acid monomer available under the trade designation ACRYLIC |
| | ACID GLACIAL from BASF Corporation, Florham Park, NJ. |
| ACM | Acrylamide Monomer available from Kowa American Corporation, New |
| | York, NY. |
| Antioxidant | A hindered thiophenol antioxidant available under the trade designation |
| | LOWINOX TBM-6 from Addivant, Danbury, CT. |
| BPO | A benzoyl peroxide initiator available under the trade designation |
| | LUPEROX A75 from Arkema, King of Prussia, PA. |
| Initiator | A free radical polymerization initiator available under the trade designation |
| | VAZO 64 from the Dupont Company, Wilmington, DE. |
| Lanolin | A complex, waxy substance containing varying amounts of long chain waxy |
| | esters and lanolin alcohols, acids, and polycarbons, available under the trade |
| | designation LANOLIN USP (PHARMACUTICAL LIGHT GRADE) from |
| | Rita Corporation, Crystal Lake, IL. |
| Carbon | A chain transfer agent available under the trade designation CARBON-¹³C |
| Tetrabromide | TETRABROMIDE from Millipore Sigma (formerly known |
| | as Sigma Aldrich) St. Louis, MO. |
| Mineral Oil | A mineral oil or paraffin oil which is a mixture of higher alkanes from a |
| | mineral source, available under trade designation 831AA MINERAL OIL, |
| | from Vi-Jon Incorporated, St. Louis MO. |
| Isopropyl | Isopropyl Alcohol available from Millipore Sigma (formerly known as |
| Alcohol | Sigma Aldrich) St. Louis, MO. |
| Heptane | Heptane available from Millipore Sigma (formerly known as Sigma |
| | Aldrich) St. Louis, MO. |
| Ethyl Acetate | Ethyl Acetate available from Millipore Sigma (formerly known as Sigma |
| | Aldrich) St. Louis, MO. |
| Toluene | Toluene available from Millipore Sigma (formerly known as Sigma |
| | Aldrich) St. Louis, MO. |
| Acetone | Acetone available from Millipore Sigma (formerly known as Sigma |
| | Aldrich) St. Louis, MO. |
| Methanol | Methanol available from Millipore Sigma (formerly known as Sigma |
| | Aldrich) St. Louis, MO. |
| DAIB | A dodecyl acrylate isomer blend (as described in U.S. Pat. No. 9,102,774 |
| | (Clapper et al.)) obtained from 3M Company, St. Paul MN. |
| IBOA | Isobornyl Acrylate monomer (IBOA) available under the trade designation |
| | SR506A from Arkema Inc., King of Prussia, PA. |
| IPM | Isopropyl myristate, a plasticizer available under the trade designation |
| | LIPONATE IPM from Vantage Specialty Ingredients, Inc., Warren, NJ. |
| IRGACURE | 2,2-Dimethoxy-1,2-diphenylethan-1-one, a photoinitiator available under |
| 651 | the trade designation IRGACURE 651 from BASF Corporation, Florham |
| | Park, NJ. |
| Triazine | 2,4-Bis(trichloromethyl)-6-(3,4-dimethoxyphenyl)-s-triazine, made by the |
| Crosslinker | co-trimerization of an arylnitrile with trichloroacetonitrile in the |
| | presence of HCl gas and a Lewis acid such as AlCl₃, AlBr₃, etc., using |
| | the procedure described in Bulletin of the Chemical Society Japan, |
| | Volume 42, page 2924 (1969). |
| 2024 | A Type 2024 aluminum panel, identified under the item number 88835K14, |
| Aluminum | obtained from McMaster Carr, Chicago, IL. |

Three commonly used aluminum alloy series are 2000, 6000, and 7000. The most difficult to mask with minimal leakage distance was 2024 followed by 7075, then 6061. The following tests were done on aluminum alloy 2024.

### Test Methods

### Chromic Acid Anodization (CAA)-Leakage Distance

Unpolished aluminum 2024 alloy panels, measuring 4 inches by 6 inches by 0.05 inch (10.2 centimeters (cm) by 15.2 centimeters (cm) by 1.27 millimeters (mm)), having a surface roughness average (Ra) value of 0.382 micrometers to 0.463 micrometer (as measured using a MARSURFM-300 PROFILOMETER with probe RD 18C, available from Mahr Federal Incorporated, Providence, R.I.) were employed. The panels were cleaned using an Alkaline-Deoxizer treatment as follows. First the panels were immersed in a solution of OAKITE 166 (alkaline aluminum cleaner, available from Oakite Products, Incorporated, Berkeley Heights, N.J.) at 150° F.+/−15° F. (66° C.+/−8.3° C.) for 5-7 minutes (min), at a concentration of 6-7 ounces/gallon (45-53 grams/liter). Subsequently, after rinsing with water at about 72° F. (22° C.), the panel was immersed in a solution of CHEMETALL DEOXIDIZER LNC (15-20 volume-% concentration; available from Oakite Products, Incorporated, Berkeley Heights, N.J.) at 72° F. (22° C.) for no more than 5 minutes. The panels were then rinsed with water, and dried using compressed air.

Within about 2 hours, two tape strips of a tape construction, cut with a razor blade and measuring 1 inch wide by 4 inches long (2.5 cm by 10.2 cm), were applied to one side of a cleaned aluminum panel by hand, followed by rolling down the samples with a rubber roller one time in one direction, then running a plastic scraper blade down along the length of the tape strip several times to ensure intimate contact with the panel, especially along the edges. Another two tape strips of different construction were then applied in the same manner to the same side of the aluminum panel. Another four tape strips of two different constructions were then applied in the same manner to the opposite side of the aluminum panel. The taped panel was allowed to dwell at about 72° F. (22° C.) for 2 to 4 hours before anodization. Next the taped panel was anodized for about 50 minutes at 95° F.+/−5° F. (35° C.+/−2.8° C.) and 40 Volts in a bath having a chromic acid concentration of between 40 grams/liter 52 grams/liter and a pH of 0.5 to 0.9. After removal from the acid bath the panel was rinsed with the water at about 72° F. (22° C.) for 1-2 min. The anodized, taped panel was placed in a hot water seal tank at approximately 200° F. (93° C.) for about 5-10 min, then dried using compressed air.

The resulting anodized taped panels were evaluated at 20× magnification for the leakage distance of chromic acid under both lengthwise edges of each tape strip at 0.5 inch (12.7 mm) intervals for a total of 10 data points/tape strip, and a total of 20 data points/2 test strips. The first and last data points were taken at 1.0 inch (25.4 millimeters) from the end of each strip. The leakage area was visible due to anodization having taken place under the tape where the acid leaked. The average of the 20 data points was reported. In some cases the leaking distance was excessive. In those cases, leakage distance was measured at 1.0 inch (25.4 mm) intervals for a total of 6 data points/tape strip, and a total of 12 data points/2 test strips. The average of the 12 data points was reported. In some cases, the tape strip fell of the substrate in the chromic acid bath. In those instances, the result was recorded as “FAIL.”

### Peel Adhesion Strength

Peel adhesion strength was measured according to ASTM D-3330/D3330M-04 (2010): “Peel Adhesion of Pressure-Sensitive Tape”—Test Method A, with the following modifications. The tape samples were held for at least 24 hours at a temperature of about 22° C. and 50% relative humidity prior to testing. A 1.0-inch (25.4 mm) wide tape strip was applied to Type 2024 Aluminum Panels cleaned as described in the test method “Chromic Acid Anodization (CAA)-Leakage Distance” above. A 4.5-pound (2.04 kilogram) hard rubber roller was passed twice in each direction over the tape strip to ensure intimate contact. After a dwell time of 3-5 min, the peel adhesion strength was measured at a peel rate of 12 inches/minute (30 cm/min) and an angle of 180° from the surface. Three test strips were evaluated, and the average value reported.

### Clean Removal Test

After the Chromic Acid Anodization test, the panels were measured for leakage. Once completed, the tape strips were removed by hand peeling at a rate of about 12 inches/minute (30 cm/min) and an angle of about 180° from the surface. The surface below the tape strips was visually analyzed for adhesive residue. If the tape strips could be removed without leaving residue, the samples were recorded as PASS. If there was residue, the samples were recorded as FAIL.

### Adhesive Coating Thickness Test

The adhesive coating thickness was calculated from adhesive coating weight by the following process. For reference, a 24 square inch section of the uncoated polyester backing was measured on a precision scale to an accuracy of 0.005 gram. The polyester backing weight in grams was multiplied by 15.4 to convert into grains/24 square inches. In a similar way, the adhesive coated polyester film was weighed. The adhesive coating weight in grains is the difference in weight between the coated film and the uncoated polyester film. The coating thickness is then calculated by the following formula:

Coating Thickness in micrometers=Coating Weight in grains×4.2333

### Backing Flexibility

The flexibilities (i.e., flexural rigidity) of materials used as backings were calculated using the following equation:

D=Et³/12(1−v²)

Where D is the backing flexibilities, E is the tensile or Young's Modulus of the backing, t is the backing thickness, and v is Poisson's ratio of the backing material. It is desirable to have flexibilities values of less than 0.00324 N-m, or 0.00096 N-m, or 0.0002075 N-m, or 0.00012 N-m, or lower.

### Dynamic Mechanical Analysis (DMA) Test Method

Dynamic Mechanical Analysis was performed on adhesive samples, using an ARES (Model: ARES-M) rheometer (available from TA Instrument Inc. (New Castle, Del., USA). Sample preparation and testing was done as follows. Adhesive sheets of at least 1 millimeter thickness were prepared on a polyester film or polycoated paper coated with silicone release layer, either by solvent drying or by stacking up thinner sheets. A test specimen disc of 8 mm diameter was punched out of an adhesive sheet, using a die cut tool. The adhesive disc was placed on a bottom steel plate (8 mm in diameter) and the sample was compressed by lowering the top steel plate to ensure thorough contact between the adhesive and rheometer plates. If the modulus values were too low, a 25 mm diameter plate and sample disc was used to achieve better torque and reliable results. The measurement gap between rheometer plates was 1-2 mm, depending upon adhesive disc thickness. The rheometer furnace was closed and samples were equilibrated at an initial temperature of 25° C. A temperature sweep test from 25° C. to 100° C., at 1 radian/second angular frequency was performed. The temperature was increased at the rate of 3° C./min and strain level was set at 20%. Shear storage Modulus (G′), shear loss modulus (G″) were recorded. Tangent delta values were calculated as G″/G′ for the adhesive samples.

### Inherent Viscosity (IV) Test

The inherent viscosity values reported in the examples that follow were obtained by the conventional method used by those skilled in the art. The inherent viscosity values were obtained using a Cannon-Fenske #50 viscometer (available from Cannon Instrument Company, State College, Pa.) in a water bath controlled at 25° C. to measure the flow time of 10 milliliter (ml) of polymer solution (0.2 gram (g) per deciliter polymer in tetrahydrofuran). The examples and controls were run under identical conditions. The test procedure followed and the apparatus used are explained in detail in the Textbook of Polymer Science, F. W. Billmeyer. Wiley-Interscience, 2^{nd} Edition, 1971 under: Polymer chains and their characterizations, D. Solution viscosity and Molecular Size, pages 84 and 85.

### Preparation of Acrylic Based Pressure Sensitive Adhesive Compositions

### Preparation of Adhesive Copolymers

The materials in Table 1A were used to make Adhesive Copolymer 1 with 94 parts isooctyl acrylate and 6 parts acrylic acid. The isooctyl acrylate, acrylic acid, heptane, acetone, initiator, and the pre-mix stock solution of carbon tetrabromide and isooctyl acrylate were placed in a glass reaction bottle. The heptane to acetone ratio was 65:35. The reaction bottle was purged with nitrogen, then sealed, and placed in a 55° C. bath and tumbled for 24 hours to produce the polymer. The resulting inherent viscosity was 0.81 deciliter/gram (dl/gram).

TABLE 1A
Adhesive Copolymer 1 Composition

| | Adhesive |
|---|---|
| | Copolymer 1 |
| Materials | Wt-% |
| Isooctyl Acrylate | 37.7 |
| Acrylic Acid | 2.7 |
| Carbon Tetrabromide in | 0.02 |
| Pre-mixed Stock Solution | |
| Isooctyl Acrylate in Pre- | 4.5 |
| Mixed Stock Solution | |
| Heptane | 35.8 |
| Acetone | 19.3 |
| Ethyl Acetate | 0.0 |
| Initiator | 0.135 |
| Total | 100 |
| % Solids | 45 |
| Inherent Viscosity | 0.81 |
| (dl/gram) | |

The materials in Table 1B were used to make Adhesive Copolymer 2 with 97 parts isooctyl acrylate and 3 parts acrylamide. Isooctyl acrylate, acrylamide, BPO, ethyl acetate, and isopropyl alcohol were place in a glass reaction bottle. The percent solids in the reaction bottle was 40%. The reaction bottle was purged with nitrogen, then sealed, and placed in a 55° C. bath and tumbled for 24 hours to produce the polymer. The inherent viscosity was 1.17 dl/gram. Heptane and the antioxidant were then added to achieve the final dilution.

The materials listed in Table 1B were used to make Adhesive Copolymer 3 consisting of 96 parts isooctyl acrylate and 4 parts acrylamide. The isooctyl acrylate, acrylamide, BPO, and ethyl acetate were placed in a glass reaction bottle. The percent solids in the reaction bottle was 40%. The reaction bottle was purged with nitrogen, then sealed, and placed in a 55° C. bath and tumbled for 24 hours to produce the polymer. The inherent viscosity was 1.34 dl/g. Heptane and the antioxidant were then added to achieve the final dilution.

The materials used in Table 1B were used to make Adhesive Copolymer 4 consisting of 93 parts isooctyl acrylate and 7 parts acrylamide. The Isooctyl acrylate, acrylamide, BPO, methanol, and ethyl acetate were placed in a glass reaction bottle. The percent solids in the reaction bottle was 40%. The reaction bottle was purged with nitrogen, then sealed, and placed in a 55° C. bath and tumbled for 24 hours to produce the polymer. The inherent viscosity was 1.22 dl/gram. Heptane was then added to achieve the final dilution.

TABLE 1B
Adhesive Copolymer 2, 3, and 4 Compositions

| | Adhesive | Adhesive | Adhesive |
|---|---|---|---|
| | Copolymer | Copolymer | Copolymer |
| | 2 | 3 | 4 |
| Materials | Wt-% | | |
| Acrylamide | 0.95 | 0.83 | 1.57 |
| BPO | 0.05 | 0.03 | 0.04 |
| Ethyl Acetate | 47.45 | 31.44 | 30.31 |
| Methanol | 0 | 0 | 3.38 |
| Isooctyl Acrylate | 30.64 | 20.03 | 20.88 |
| Isopropyl Alcohol | .48 | 0 | 0 |
| Antioxidant | 0.16 | 0.10 | 0 |
| Heptane | 20.07 | 47.56 | 43.82 |
| Total | 100 | 100 | 100 |
| Inherent Viscosity | 1.17 | 1.34 | 1.22 |
| (dl/g) | | | |
| % Solids | 33.5 | 21.0 | 22.7 |

### Preparation of BPO Pre-Mix Solution

The materials shown in Table 2 were mixed in a container using a mechanical shaker for about 20 minutes to provide a BPO Pre-Mix Composition which was then used in PSA Adhesive Solutions 1 and 2.

TABLE 2
BPO Pre-Mix Compositions

| | BPO Pre-Mix Solution |
|---|---|
| Material | Wt-% |
| Toluene | 89.6 |
| BPO | 10.4 |
| Total | 100.0 |

### Preparation of Pressure Sensitive Adhesive (PSA) Compositions (Solutions)

The materials shown in Table 3A were mixed in a container and mechanically rolled for about 60 min to provide the PSA Compositions Solutions 1, 2, 3, and 4, which were then used in Pressure Sensitive Tape Examples C1, C2, 1, and 2, respectively.

TABLE 3A
PSA Compositions (Solutions) 1, 2, 3, and 4

| | PSA | PSA | PSA | PSA |
|---|---|---|---|---|
| | Composition | Composition | Composition | Composition |
| | 1 | 2 | 3 | 4 |
| Material | Wt-% | | | |
| Adhesive | 93.4 | 88.7 | 95.2 | 90.5 |
| Copolymer 3 | | | | |
| Adhesive | 0.0 | 2.2 | 0.0 | 2.2 |
| Copolymer 1 | | | | |
| BPO Pre-Mix | 3.8 | 3.8 | 0.0 | 0.0 |
| Solution | | | | |
| Toluene | 2.9 | 5.3 | 4.8 | 7.3 |
| Total | 100.0 | 100.0 | 100.0 | 100.0 |
| % Solids | 20.0 | 20.0 | 20.0 | 20.0 |
| Monomer wt-% | 96-4-0 | 95.9- | 96-4-0 | 95.9- |
| Ratio | | 3.8-0.3 | | 3.8-0.3 |
| *(IOA-ACM - | | | | |
| AA) | | | | |
| BPO Parts | 1.5 | 1.5 | 0 | 0 |

*IOA = Isooctyl Acrylate, ACM = Acrylamide, AA = Acrylic Acid

The materials shown in Table 3B were mixed in a container and mechanically rolled for about 60 min to provide the PSA Compositions Solutions 5, 6, 7, and 8, which were then used in Pressure Sensitive Tape Examples 3, 4, 5, and C3.

TABLE 3B
PSA Compositions (Solutions) 5, 6, 7, and 8

| | PSA | PSA | PSA | PSA |
|---|---|---|---|---|
| | Com- | Com- | Com- | Com- |
| | position | position | position | position |
| | 5 | 6 | 7 | 8 |
| Material | Wt-% | | | |
| Adhesive | 86.58 | 79.37 | 86.58 | 79.37 |
| Copolymer 3 | | | | |
| Lanolin Additive | 1.82 | 3.33 | 0 | 0 |
| Mineral Oil | 0 | 0 | 1.82 | 3.33 |
| Additive | | | | |
| Toluene | 11.60 | 17.30 | 11.60 | 17.30 |
| Total | 100.0 | 100.0 | 100.0 | 100.0 |
| % Solids | 20.0 | 20.0 | 20.0 | 20.0 |
| Monomer wt-% | 96-4-0 | 96-4-0 | 96-4-0 | 96-4-0 |
| Ratio | | | | |
| *(IOA-ACM- | | | | |
| AA) | | | | |
| Lanolin Parts | 10 | 20 | 0 | 0 |
| Mineral Oil Parts | 0 | 0 | 10 | 20 |

*IOA = Isooctyl Acrylate, ACM = Acrylamide, AA = Acrylic Acid

The materials shown in Table 3C were mixed in a container and mechanically rolled for about 60 min to provide the PSA Compositions Solutions 9, 10, 11, 12, and 13, which were then used in Pressure Sensitive Tape Examples 6, 7, 8, 9, 10.

TABLE 3C
PSA Compositions (Solutions) 9, 10, 11, 12, and 13

| | PSA | PSA | PSA | PSA | PSA |
|---|---|---|---|---|---|
| | Composition | Composition | Composition | Composition | Composition |
| | 9 | 10 | 11 | 12 | 13 |
| Material | Wt-% | | | | |
| Adhesive | 59.7 | 58.2 | 56.9 | 55.5 | 54.3 |
| Copolymer 2 | | | | | |
| Lanolin Additive | 0.0 | 0.49 | 1.0 | 1.4 | 1.8 |
| Toluene | 40.3 | 41.3 | 42.2 | 43.1 | 43.9 |
| Total | 100.0 | 100.0 | 100.0 | 100.0 | 100.0 |
| Monomer wt-% | 97-3-0 | 97-3-0 | 97-3-0 | 97-3-0 | 97-3-0 |
| Ratio | | | | | |
| *(IOA-ACM- | | | | | |
| AA) | | | | | |
| % Solids | 20.0 | 20.0 | 20.0 | 20.0 | 20.0 |
| Lanolin Parts | 0 | 2.5 | 5.0 | 7.5 | 10.0 |

*IOA = Isooctyl Acrylate, ACM = Acrylamide, AA = Acrylic Acid

The materials shown in Table 3D were mixed in a container and mechanically rolled for about 60 min to provide the PSA Compositions Solutions 14, 15, 16, 17, and 18, which were then used in Pressure Sensitive Tape Examples 11, 12, 13, 14, 15.

TABLE 3D
PSA Compositions (Solutions) 14, 15, 16, 17, and 18

| | PSA | PSA | PSA | PSA | PSA |
|---|---|---|---|---|---|
| | Composition | Composition | Composition | Composition | Composition |
| | 14 | 15 | 16 | 17 | 18 |
| Material | Wt-% | | | | |
| Adhesive | 95.2 | 92.9 | 90.7 | 88.6 | 86.8 |
| Copolymer 3 | | | | | |
| Lanolin | 0.0 | 0.5 | 1.0 | 1.4 | 1.8 |
| Additive | | | | | |
| Toluene | 4.8 | 6.6 | 8.3 | 10.0 | 11.6 |
| Total | 100.0 | 100.0 | 100.0 | 100.0 | 100.0 |
| Monomer wt-% | 96-4-0 | 96-4-0 | 96-4-0 | 96-4-0 | 96-4-0 |
| Ratio | | | | | |
| *(IOA-ACM- | | | | | |
| AA) | | | | | |
| % Solids | 20.0 | 20.0 | 20.0 | 20.0 | 20.0 |
| Lanolin Parts | 0.0 | 2.5 | 5.0 | 7.5 | 10.0 |

*IOA = Isooctyl Acrylate, ACM = Acrylamide, AA = Acrylic Acid

The materials shown in Table 3E were mixed in a container and mechanically rolled for about 60 min to provide the PSA Compositions Solutions 19, and 20, which were then used in Pressure Sensitive Tape Examples C4 and C5.

TABLE 3E
PSA Compositions (Solutions) 19 and 20

| | PSA Composition 19 | PSA Composition 20 |
|---|---|---|
| Material | Wt-% | |
| Adhesive Copolymer 4 | 88.3 | 80.3 |
| Lanolin Additive | 0.0 | 1.8 |
| Toluene | 11.7 | 17.9 |
| Total | 100.0 | 100.0 |
| Monomer wt-% Ratio | 93-7-0 | 93-7-0 |
| *(IOA-ACM-AA) | | |
| % Solids | 20.0 | 20.0 |
| Lanolin Parts | 0.0 | 10.0 |

*IOA = Isooctyl Acrylate, ACM = Acrylamide, AA = Acrylic Acid

### Preparation of Film Surface Treatment

A 3.0 mil (0.0762 mm) PET film available under the trade designation SKYROL SG00L 300 gauge POLYESTER FILM, from SKC Films, Covington, Ga. was corona treated on one side at an energy of about 0.3 Joule/centimeter squared with a range of 0.2 to 0.4 Joule/centimeter squared.

### Preparation of Pressure Sensitive Adhesive Tapes

### Method A

For PSA compositions containing BPO, the PSA composition solution was coated onto the corona-treated side of the PET film using a notch bar coater. The tape was then dried in a forced air oven for 5 min at 65.6° C. (150° F.) and then 5 min at 149° C. (300° F.).

### Method B

For PSA compositions not containing BPO, the PSA composition solution was coated onto the corona-treated side of the PET film using a notch bar coater. The tape was then air dried for 5 min and then dried in a forced air oven for 5 min at 65.6° C. (150° F.

Tables 4A-4C list Pressure Sensitive Tapes Made from PSA Composition Solutions with associated Leakage, Clean Removal, and Adhesion Results. The adhesive coating thickness as measured by the Adhesive Coating Thickness Test listed above is reported in Tables 4A (13 micrometer; with a range of 12.7-14.0 micrometers), Table 4B (23 micrometers; with a range of 16.9-27.9 micrometers) and Table 4C (33 micrometers; with a range of 28.8-35.6 micrometers). PSA Examples C2 and Ex2 were prepared by blending the Adhesive Copolymer Solutions recited in Table 3A. That is, the two Adhesive Copolymer Solutions for preparing Examples C2 and Ex 2 (i.e., Adhesive Copolymer Solution 3 and Adhesive Copolymer Solution 1) were not copolymerized, but rather blended after polymerization. The designation “NT” in tables 4A-4C indicate that the example was not prepared for that particular adhesive coating thickness.

TABLE 4A
Pressure Sensitive Tapes Made from PSA Composition Solutions and Leakage,
Clean Removal, and Adhesion Results (target 13 micrometers adhesive coating thickness)

| | | | | Mineral | | Adh Thick- | **Leakage | Clean | Adh to Alkaline |
|---|---|---|---|---|---|---|---|---|---|
| PSA | | BPO | Lanolin | Oil | Monomer Parts | ness (micro | micro-meters | Removal | De-Ox Alum |
| Ex | PSA | Parts | Parts | Parts | IOA-ACM-AA | meters) | (mils) | (Pass/Fail) | N/m (oz/in) |
| *C1 | 1 | 1.5 | | | 96-4-0 | NT | NT | NT | NT |
| *C2 | 2 | 1.5 | | | 95.9-3.8-0.3 | NT | NT | NT | NT |
| 1 | 3 | 0 | | | 96-4-0 | NT | NT | NT | NT |
| 2 | 4 | 0 | | | 95.9-3.8-0.3 | NT | NT | NT | NT |
| 3 | 5 | | 10 | 0 | 96-4-0 | NT | NT | NT | NT |
| 4 | 6 | | 20 | 0 | 96-4-0 | NT | NT | NT | NT |
| 5 | 7 | | 0 | 10 | 96-4-0 | NT | NT | NT | NT |
| C3 | 8 | | 0 | 20 | 96-4-0 | NT | NT | NT | NT |
| 6 | 9 | | 0 | | 97-3-0 | 14.8 | 568 (22.4) | Pass | 70.1 (6.4) |
| 7 | 10 | | 2.5 | | 97-3-0 | 14.0 | 513 (20.2) | Pass | 38.3 (3.5) |
| 8 | 11 | | 5 | | 97-3-0 | 11.9 | 538 (21.2) | Pass | 20.8 (1.9) |
| 9 | 12 | | 7.5 | | 97-3-0 | 14.0 | 533 (21.0) | Pass | 21.9 (2.0) |
| 10 | 13 | | 10 | | 97-3-0 | 10.6 | 485 (19.1) | Pass | 17.5 (1.6) |
| 11 | 14 | | 0 | | 96-4-0 | 13.1 | 457 (18.0) | Pass | 36.1 (3.3) |
| 12 | 15 | | 2.5 | | 96-4-0 | 15.2 | 437 (17.2) | Pass | 21.9 (2.0) |
| 13 | 16 | | 5 | | 96-4-0 | 16.1 | 495 (19.5) | Pass | 23.0 (2.1) |
| 14 | 17 | | 7.5 | | 96-4-0 | 14.4 | 467 (18.4) | Pass | 15.3 (1.4) |
| 15 | 18 | | 10 | | 96-4-0 | 13.1 | 445 (17.5) | Pass | 10.9 (1.0) |
| C4 | 19 | | 0 | | 93-7-0 | 16.1 | FO | Fail | 31.7 (2.9) |
| C5 | 20 | | 10 | | 93-7-0 | 14.0 | FO | Fail | 2.2 (0.2) |

*Comparative Examples C1 and C2 used Coating Method A. All other entries in Table 4A used Coating Method B.
**FO = tape fell off in bath

TABLE 4B
Pressure Sensitive Tapes Made from PSA Composition Solutions and Leakage,
Clean Removal, and Adhesion Results (target 23 micrometer adhesive coating thickness)

| | | | | | Monomer | Adh | **Leakage | | |
|---|---|---|---|---|---|---|---|---|---|
| | | | | Mineral | Parts | Thickness | micro- | Clean | Adh to Alkaline |
| PSA | | BPO | Lanolin | Oil | IOA-ACM- | (micro | meters | Removal | De-Ox Alum |
| Ex | PSA | Parts | Parts | Parts | AA | meters) | (mils) | (Pass/Fail) | N/m (oz/in) |
| *C1 | 1 | 1.5 | | | 96-4-0 | 24.1 | FO | Fail | NT |
| *C2 | 2 | 1.5 | | | 95.9-3.8-0.3 | 22.4 | FO | Fail | NT |
| 1 | 3 | 0 | | | 96-4-0 | 28.8 | 630 (24.8) | NT | NT |
| 2 | 4 | 0 | | | 95.9-3.8-0.3 | 21.6 | 709 (27.9) | NT | NT |
| 3 | 5 | | 10 | 0 | 96-4-0 | 25.4 | 389 (15.3) | Pass | 36.1 (3.3) |
| 4 | 6 | | 20 | 0 | 96-4-0 | 23.7 | 323 (12.7) | Pass | 23.0 (2.1) |
| 5 | 7 | | 0 | 10 | 96-4-0 | 20.3 | 493 (19.4) | Pass | 42.7 (3.9) |
| C3 | 8 | | 0 | 20 | 96-4-0 | 22.9 | 889 (35.0) | Pass | 39.7 (2.9) |
| 6 | 9 | | 0 | | 97-3-0 | 25.0 | 658 (25.9) | Fail | 118 (10.8) |
| 7 | 10 | | 2.5 | | 97-3-0 | 22.9 | 640 (25.2) | Fail | 49.3 (4.5) |
| 8 | 11 | | 5 | | 97-3-0 | 21.6 | 584 (23.0) | Fail | 36.1 (3.3) |
| 9 | 12 | | 7.5 | | 97-3-0 | 29.6 | 655 (25.8) | Fail | 30.6 (2.8) |
| 10 | 13 | | 10 | | 97-3-0 | 25.8 | 632 (24.9) | Pass | 27.4 (2.5) |
| 11 | 14 | | 0 | | 96-4-0 | 19.1 | 554 (21.8) | Pass | 118 (10.8) |
| 12 | 15 | | 2.5 | | 96-4-0 | 21.6 | 551 (21.7) | Pass | 30.6 (2.8) |
| 13 | 16 | | 5 | | 96-4-0 | 17.8 | 472 (18.6) | Pass | 17.5 (1.6) |
| 14 | 17 | | 7.5 | | 96-4-0 | 20.7 | 498 (19.6) | Pass | 24.1 (2.2) |
| 15 | 18 | | 10 | | 96-4-0 | 19.5 | 480 (18.9) | Pass | 19.7 (1.8) |
| C4 | 19 | | 0 | | 93-7-0 | 28.4 | FO | Pass | 65.7 (6.0) |
| C5 | 20 | | 10 | | 93-7-0 | 26.2 | FO | Fail | 6.6 (0.6) |

*Comparative Examples C1 and C2 used Coating Method A. All other entries in Table 4B used Coating Method B.
**FO = tape fell off in bath.

TABLE 4C
Pressure Sensitive Tapes Made from PSA Composition Solutions and Leakage,
Clean Removal, and Adhesion Results (target 33 micrometer adhesive coating thickness)

| | | | | Mineral | | Adhesive | ****Leakage | Clean | Adh to Alkaline |
|---|---|---|---|---|---|---|---|---|---|
| PSA | | BPO | Lanolin | Oil | Monomer Parts | Thick-ness | micro-meters | Removal | De-Ox Alum N/m |
| Ex | PSA | Parts | Parts | Parts | IOA-ACM-AA | (micro-meters) | (mils) | (Pass/Fail) | (oz/in) |
| *C1 | 1 | 1.5 | | | 96-4-0 | NT | NT | NT | NT |
| *C2 | 2 | 1.5 | | | 95.9-3.8-0.3 | NT | NT | NT | NT |
| 1 | 3 | 0 | | | 96-4-0 | NT | NT | NT | NT |
| 2 | 4 | 0 | | | 95.9-3.8-0.3 | NT | NT | NT | NT |
| 3 | 5 | | 10 | 0 | 96-4-0 | NT | NT | NT | NT |
| 4 | 6 | | 20 | 0 | 96-4-0 | NT | NT | NT | NT |
| 5 | 7 | | 0 | 10 | 96-4-0 | NT | NT | NT | NT |
| C3 | 8 | | 0 | 20 | 96-4-0 | NT | NT | NT | NT |
| 6 | 9 | | 0 | | 97-3-0 | NT | 691 (27.2) | Pass | 170 (15.5) |
| 7 | 10 | | 2.5 | | 97-3-0 | 22.9 | 678 (26.7) | Pass | 78.8 (7.2) |
| 8 | 11 | | 5 | | 97-3-0 | 31.8 | 627 (24.7) | Pass | 44.9 (4.1) |
| 9 | 12 | | 7.5 | | 97-3-0 | 39.8 | 663 (26.1) | Pass | 39.4 (3.6) |
| 10 | 13 | | 10 | | 97-3-0 | 36.4 | 648 (25.5) | Pass | 35.0 (3.2) |
| 11 | 14 | | 0 | | 96-4-0 | 30.5 | 577 (22.7) | Pass | 204 (18.6) |
| 12 | 15 | | 2.5 | | 96-4-0 | 30.9 | 566 (22.3) | Pass | 33.9 (3.1) |
| 13 | 16 | | 5 | | 96-4-0 | 32.2 | 559 (22.0) | Pass | 30.6 (2.8) |
| 14 | 17 | | 7.5 | | 96-4-0 | 32.6 | 564 (22.2) | Pass | 39.4 (3.6) |
| 15 | 18 | | 10 | | 96-4-0 | 32.6 | 528 (20.8) | Pass | 21.9 (2.0) |
| C4 | 19 | | 0 | | 93-7-0 | 35.6** | FO | Fail | 97.4 (8.9) |
| C5 | 20 | | 10 | | 93-7-0 | 34.7*** | FO | Pass | 5.5 (0.5) |

*Comparative Examples C1 and C2 used Coating Method A. All other entries in Table 4C used Coating Method B.
**Coating thickness estimated on 12 square inch (77.4 square centimeter) sample
***Coating thickness estimated on a 6 square inch (38.7 square centimeter) sample
****FO = tape fell off in bath

### Preparation of Acrylic Adhesive Precursors (100% Solids)

Acrylic Adhesive Precursor compositions were prepared using the materials and amounts shown in Table 5, as follows. A quart glass jar was charged various amounts of DAIB and IBOA, and IRGACURE 651 and stirred until the photoinitiator had dissolved and a homogenous mixture was obtained. The mixture was degassed by introducing nitrogen gas into it through a tube inserted through an opening in the jar's cap and bubbling vigorously for at least 5 min. After decreasing the nitrogen flow rate the contents of the jar were gently mixed and exposed to UVA light until a pre-adhesive syrup having a viscosity deemed suitable for coating was formed.

The UVA irradiation was provided using a STARFIRE MAX 365 nanometer LED array from Phoseon Technologies (Hillsboro, Oreg.) positioned 3 inches (7.6 centimeters) from the outer surface of the glass jar. The nitrogen supply was then switched to air and this was introduced into the jar for at least five minutes. The UVA light source had a UVA peak emission wavelength in the range of 350 to 400 nanometers.

TABLE 5
Acrylic Adhesive Precursor Compositions*

| | Adhesive | Adhesive | Adhesive | Adhesive | Adhesive | Adhesive |
|---|---|---|---|---|---|---|
| Component | Precursor 1 | Precursor 2 | Precursor 3 | Precursor 4 | Precursor 5 | Precursor 6 |
| Composition | 100/0 | 98/2 | 97/3 | 96/4 | 95/5 | 94/6 |
| Ratio | | | | | | |
| DAIB | 400 | 392 | 388 | 384 | 380 | 376 |
| IBOA | 0 | 8 | 12 | 16 | 20 | 24 |
| Photoinitiator | 0.16 | 0.16 | 0.16 | 0.16 | 0.16 | 0.16 |

*All amounts listed are in grams

### Preparation of Acrylic Adhesive Compositions (100% Solids)

Next, 100 gram quantities of the Adhesive Precursor Compositions were measured into 8 ounce glass jars. To each 100 gram Adhesive Precursor quantity, an additional 0.200 gram IRGACURE 651 photoinitiator and various amounts of triazine crosslinker were added to the Adhesive Precursor Compositions and mixed on a roller until both the photoinitiator and crosslinker were dissolved. The amounts of triazine crosslinker are shown in Table 6. For adhesive formulations that contained a plasticizer, a total 50 grams of the above compositions were added to a 4-ounce (118 milliliters) glass jar. To this glass jar, various amounts of plasticizer IPM were added to give the desired ratio of plasticizer and again mixed on a roller until a homogeneous mixture was obtained. The final Acrylic Adhesive Compositions are shown in Table 6.

TABLE 6
Acrylic Adhesive Compositions (100% Solids)

| | | Acrylic Compositions* | | |
|---|---|---|---|---|
| | Materials Ratio | Acrylic | | |
| | DAIB/ | Adhesive | | |
| Acrylic | IBOA/ | Precursor | Triazine | IPM |
| Composition | XL/IPM | Input Number | Crosslinker | Plasticizer |
| ID | (w:w) | (100 parts) | (pph) | (pph) |
| 1 | 100/0/0/0 | 1 | 0 | 0 |
| 2 | 94/6/0/0 | 6 | 0 | 0 |
| 3 | 100/0/0.05/0 | 1 | 0.05 | 0 |
| 4 | 100/0/0.10/0 | 1 | 0.1 | 0 |
| 5 | 98/2/0.05/0 | 2 | 0.05 | 0 |
| 6 | 98/2/0.10/0 | 2 | 0.1 | 0 |
| 7 | 96/4/0.05/0 | 4 | 0.05 | 0 |
| 8 | 96/4/0.10/0 | 4 | 0.1 | 0 |
| 9 | 94/6/0.05/0 | 6 | 0.05 | 0 |
| 10 | 94/6/0.10/0 | 6 | 0.1 | 0 |
| 11 | 97/3/0.075/0 | 3 | 0.075 | 0 |
| 12 | 97/3/0.075/4 | 3 | 0.075 | 4 |
| 13 | 97/3/0.075/6 | 3 | 0.075 | 6 |
| 14 | 96/4/.01/0 | 4 | 0.01 | 0 |
| 15 | 96/4/.01/4 | 4 | 0.01 | 4 |
| 16 | 96/4/.03/0 | 4 | 0.03 | 0 |
| 17 | 96/4/.03/4 | 4 | 0.03 | 4 |
| 18 | 96/4/.05/0 | 4 | 0.05 | 0 |
| 19 | 96/4/.05/4 | 4 | 0.05 | 4 |
| 20 | 95/5/.01/0 | 5 | 0.01 | 0 |
| 21 | 95/5/.01/4 | 5 | 0.01 | 4 |
| 22 | 95/5/.03/0 | 5 | 0.03 | 0 |
| 23 | 95/5/.03/4 | 5 | 0.03 | 4 |
| 24 | 95/5/.05/0 | 5 | 0.05 | 0 |
| 25 | 95/5/.05/4 | 5 | 0.05 | 4 |
| 26 | 94/6/.01/0 | 6 | 0.01 | 0 |
| 27 | 94/6/.01/4 | 6 | 0.01 | 4 |
| 28 | 94/6/.03/0 | 6 | 0.03 | 0 |
| 29 | 94/6/.03/4 | 6 | 0.03 | 4 |
| 30 | 94/6/.05/0 | 6 | 0.05 | 0 |
| 31 | 94/6/.05/4 | 6 | 0.05 | 4 |

*For all Acrylic Adhesive Compositions, 0.20 pbw photoinitiator IRGACURE 651 was added to 100 pbw Acrylic Adhesive Precursor.

### Preparation of Acrylic Tapes: Method C

The resulting Acrylic Adhesive Compositions were then coated onto the corona-treated side of a 0.003 inch (76 micrometers) thick polyester film using a notch bar coater” having various gap settings to provide different adhesive thicknesses. The coated composition was exposed to UVA energy for about 167 seconds and 250 seconds to provide a total energy of 406 or 609 millijoules/square centimeter, respectively, in a nitrogen-inerted environment with 50 to 90 parts per million (ppm) Oxygen. The UVA light source had a UVA peak emission wavelength of 350 to 400 nanometers and was positioned over the coated Acrylic Adhesive Composition. Acrylic pressure sensitive adhesive were thereby obtained. The total energy, coating thickness, leakage distance, clean removal, and Peel Adhesion test results are summarized in Table 7.

TABLE 7
Acrylic Adhesive Tapes and UV Cure Parameters and Leakage, Clean Removal, and Peel Adhesion Strength Results

| | | Acrylic | | | | Clean | Peel Adhesion |
|---|---|---|---|---|---|---|---|
| | | Adhesive | Total | Coating | Leakage Test | Removal | Strength |
| | Composition | Composition | Energy | Thickness | ***micro-meters | Test | **N/m |
| Example | DAIB/IBOA/XL/IPM | Number | (mJ/cm²) | (micro-meters) | (mils) | (PASS/FAIL) | (ounces/inch) |
| C6 | 100/0/0/0 | 1 | 406 | 21 | 701 (27.6) | FAIL | NT |
| C7 | 100/0/0/0 | 1 | 406 | 32 | 790 (31.1) | FAIL | NT |
| C8 | 94/6/0/0 | 2 | 406 | 21 | 640 (25.2) | FAIL | NT |
| C9 | 94/6/0/0 | 2 | 406 | 32 | 640 (25.2) | FAIL | NT |
| C10 | 100/0/0.05/0 | 3 | 406 | 28 | FO | FAIL | 40.8 (22.7) |
| C11 | 100/0/0.10/0 | 4 | 406 | 28 | FO | FAIL | NT |
| C12 | 98/2/0.05/0 | 5 | 406 | 28 | 889 (35) | FAIL | 397 (36.3) |
| C13 | 98/2/0.10/0 | 6 | 406 | 28 | 1,168 (46) | PASS | 306 (28.0) |
| C14 | 96/4/0.05/0 | 7 | 406 | 28 | 864 (34) | FAIL | 241 (22.0) |
| C15 | 96/4/0.10/0 | 8 | 406 | 28 | FO | FAIL | 129 (11.8) |
| C16 | 94/6/0.05/0 | 9 | 406 | 28 | FO | FAIL | 216 (19.7) |
| C17 | 94/6/0.10/0 | 10 | 406 | 28 | FO | FAIL | 166 (15.2) |
| C18 | 97/3/0.075/0 | 11 | 406 | 35 | >2,540 (>100) | FAIL | NT |
| C19 | 97/3/0.075/4 | 12 | 406 | 35 | 1,384 (54.5) | PASS | NT |
| C20 | 97/3/0.075/6 | 13 | 406 | 35 | 1,013 (39.9) | PASS | NT |
| C21 | 96/4/.01/0 | 14 | 609 | 29.6 | 813 (32) | PASS | 639 (58.4) |
| C22 | 96/4/.01/0 | 14 | 609 | 35.1 | 1,041 (41) | PASS | NT |
| C23 | 96/4/.01/4 | 15 | 609 | 29.2 | 787 (31) | FAIL | 304 (27.8) |
| C24 | 96/4/.01/4 | 15 | 609 | 34.3 | 1,041 (41) | PASS | NT |
| C25 | 96/4/.03/0 | 16 | 609 | 29.6 | 787 (31) | PASS | 680 (62.1) |
| C26 | 96/4/.03/0 | 16 | 609 | 33.9 | 864 (34) | PASS | NT |
| *16 | 96/4/.03/4 | 17 | 609 | 30.5 | 686 (27) | PASS | 447 (40.8) |
| C27 | 96/4/.03/4 | 17 | 609 | 34.3 | 991 (39) | PASS | NT |
| C28 | 96/4/.05/0 | 18 | 609 | 29.6 | 5,055 (199) | PASS | 216 (19.7) |
| C29 | 96/4/.05/0 | 18 | 609 | 33.9 | FO | FAIL | NT |
| 17 | 96/4/.05/4 | 19 | 609 | 28.8 | 737 (29) | PASS | 525 (48) |
| C30 | 96/4/.05/4 | 19 | 609 | 33.9 | 1,118 (44) | PASS | NT |
| *18 | 95/5/.01/0 | 20 | 609 | 30.1 | 711 (28) | PASS | 520 (47.5) |
| C31 | 95/5/.01/0 | 20 | 609 | 33.9 | 914 (36) | PASS | NT |
| C32 | 95/5/.01/4 | 21 | 609 | 28.8 | 838 (33) | PASS | 342 (31.2) |
| C33 | 95/5/.01/4 | 21 | 609 | 34.3 | 965 (38) | PASS | NT |
| *19 | 95/5/.03/0 | 22 | 609 | 30.1 | 686 (27) | PASS | 709 (64.8) |
| C34 | 95/5/.03/0 | 22 | 609 | 34.3 | 940 (37) | PASS | 836 (76.4) |
| 20 | 95/5/.03/4 | 23 | 609 | 30.5 | 737 (29) | PASS | 340 (31.1) |
| C35 | 95/5/.03/4 | 23 | 609 | 34.3 | 914 (36) | PASS | NT |
| C36 | 95/5/.05/0 | 24 | 609 | 30.9 | 5,715 (225) | PASS | 246 (22.5) |
| C37 | 95/5/.05/0 | 24 | 609 | 35.1 | 1,854 (73) | PASS | NT |
| C38 | 95/5/.05/4 | 25 | 609 | 30.5 | 2,286 (90) | PASS | 136 (12.4) |
| C39 | 95/5/.05/4 | 25 | 609 | 34.3 | FO | FAIL | NT |
| *21 | 94/6/.01/0 | 26 | 609 | 28.8 | 737 (29) | PASS | 662 (60.5) |
| C40 | 94/6/.01/0 | 26 | 609 | 35.1 | 914 (36) | PASS | NT |
| 22 | 94/6/.01/4 | 27 | 609 | 30.1 | 762 (30) | PASS | 340 (31.1) |
| C41 | 94/6/.01/4 | 27 | 609 | 33.4 | 965 (38) | PASS | NT |
| 23 | 94/6/.03/0 | 28 | 609 | 30.5 | 762 (30) | PASS | 835 (76.3) |
| C42 | 94/6/.03/0 | 28 | 609 | 34.3 | 1,016 (40) | PASS | NT |
| 24 | 94/6/.03/4 | 29 | 609 | 30.1 | 711 (28) | PASS | 588 (53.7) |
| C43 | 94/6/.03/4 | 29 | 609 | 34.7 | 1,219 (48) | PASS | 656 (59.9) |
| C44 | 94/6/.05/0 | 30 | 609 | 31.3 | 1,397 (55) | PASS | 572 (52.3) |
| C45 | 94/6/.05/0 | 30 | 609 | 33.4 | 6,680 (263) | PASS | NT |
| C46 | 94/6/.05/4 | 31 | 609 | 29.2 | 787 (31) | PASS | 648 (59.2) |
| C47 | 94/6/.05/4 | 31 | 609 | 34.7 | 1,118 (44) | PASS | NT |

*Examples 16, 18, 19 and 21 were prepared changing dwell time in Leakage Test B from 4 hours to 24 hours. All samples passed (i.e. leakage distance less than 0.030 inches).
**NT = not tested.
***FO = tape fell off in bath.

### Backing Flexibility

The flexibility (i.e., flexural rigidity) of the backing materials used was calculated as described in the “Backing Flexibility” test methods above. A Young's modulus value of 4.7 GigaPascals and an average Poisson's ratio value of 0.405 were used. The result for the 3.0 mil thick Polyester Film identified as Polyester Backing 30 is shown in Table 8 below

TABLE 8
Backing Flexural Rigidity

| Backing | Flexibility (Newton-meters) |
|---|---|
| Polyester Backing 30 | 0.000207 |

TABLE 9
DMA Test Data: ′G′ and Tan Delta
Solvent Based Acrylic PSA @25 micron adhesive Thickness

| | | | | | | *Leakage |
|---|---|---|---|---|---|---|
| IOA/ACM/ | PSA | Temperature 25° C. | | Temperature 80° C. | | ave. |
| Lanolin/parts | Example | G′ Ave | tan | G′ Ave | tan | micrometers |
| BPO | # | (Pa) | delta | (Pa) | delta | (mils) |
| 96/4/0/1.5 | C1 | 41,188 | 0.3726 | 16,270 | 0.3508 | FO |
| 95.6 IOA/3.8 | C2 | 52,684 | 0.4008 | 20,701 | 0.3667 | FO |
| ACM/0.3 | | | | | | |
| AA/1.5p BPO | | | | | | |
| 96/4/0/0 | 1 | 38,640 | 0.3825 | 11,692 | 0.5855 | 630 (24.8) |
| 95.6 IOA/3.8 | | | | | | |
| ACM/0.3 AA/0p | 2 | 34,726 | 0.3786 | 13,138 | 0.5655 | 709 (27.9) |
| BPO | | | | | | |
| 96/4/10/0 | 3 | 36,463 | 0.3837 | 8,404 | 0.6434 | 389 (15.3) |
| 96/4/20/0 | 4 | 30,285 | 0.4295 | 5,827 | 0.7046 | 323 (12.7) |
| 97/3/0/0 | 6 | 31,263 | 0.3790 | 8,457 | 0.7141 | 658 (25.9) |
| 97/3/10/0 | 10 | 29,282 | 0.42585 | 6,214 | 0.7915 | 632 (24.9) |
| 93/7/10/0 | C5 | 61,771 | 0.3858 | 17,900 | 0.4715 | FO |

*FO = tape fell off in bath

The referenced descriptions contained in the patents, patent documents, and publications cited herein are incorporated by reference in their entirety as if each were individually incorporated. Various unforeseeable modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only, with the scope of the disclosure intended to be limited only by the claims set forth herein as follows.

1. A tape comprising:
a flexible backing layer having two major surfaces, wherein the backing layer has a thickness of greater than 25 micrometers; and
an acrylic-based pressure sensitive adhesive layer disposed on one major surface of the backing layer, wherein:
the acrylic-based pressure sensitive adhesive comprises the reaction of one or more (C8-C20)alkyl acrylates with one or more reinforcing monomers having a homopolymer Tg of at least 50° C.;
the acrylic-based pressure sensitive adhesive has a tan δ of at least 0.5 measured at 80° C. and an oscillating frequency of 1 radian/second; and
the acrylic-based pressure sensitive adhesive layer has a thickness of at least 5 micrometers; and
wherein, when disposed on an aluminum substrate, the tape displays clean removal from the aluminum substrate according to the Clean Removal Test, and a leakage distance of less than 762 micrometers according to the Chromic Acid Anodization-Leakage Distance Test.

2. The tape of claim 1 wherein, when disposed on an aluminum substrate, the tape displays a peel adhesion strength of less than 65 oz/in (711 N/m) according to the Peel Adhesion Test.

3. The tape of claim 1 wherein, when disposed on an aluminum substrate, the tape displays a peel adhesion of at least 2 oz/in (21.9 N/m) according to the Peel Adhesion Strength Test.

4. The tape of claim 1 wherein, when disposed on an aluminum substrate, the tape displays a leakage distance of less than 635 micrometers according to the Chromic Acid Anodization-Leakage Distance Test.

5. The tape of claim 1 wherein the backing has a thickness of up to 200 micrometers.

6. The tape of claim 1 wherein the backing has a flexibility value of less than 0.00324 Newton-meter (N-m).

7. The tape of claim 1 wherein the pressure sensitive adhesive layer has a thickness of up to 35 micrometers.

8. The tape of claim 1 wherein the backing comprises a material selected from a polyester, polystyrene, polyolefin, polytetrafluoroethylene, polyvinylidene fluoride, polyurethane, polyimide, polyamide, polyetheretherketone, liquid-crystal polyarylate, polyether sulfide, metal foil, polyphenylene sulfide, polycarbonate, polyvinyl chloride, and combinations thereof.

9. The tape of claim 1 wherein one major surface of the backing layer includes a primed or treated surface, and the acrylic-based pressure sensitive adhesive layer is disposed on the primed/treated surface of the backing layer,

10. The tape of claim 9 wherein the primed/treated surface of the backing comprises a treated surface or a chemical coating layer, or both.

11. The tape of claim 1 wherein water uptake of the acrylic-based pressure sensitive adhesive is less than 2 wt-%, based on the weight of the acrylic-based pressure sensitive adhesive, when exposed to 85% relative humidity at 85° C. for 3 days and tested for water content using the Karl-Fisher technique.

12. The tape of claim 1 wherein the acrylic-based pressure sensitive adhesive comprises a solvent-based acrylic pressure sensitive adhesive or a solventless acrylic pressure sensitive adhesive.

13. A method of anodizing an aluminum surface, the method comprising:
providing a substrate having an aluminum surface;
applying the tape of claim 1 to mask the aluminum surface and form a masked substrate; and
exposing the masked substrate to an electrolyte solution comprising an acid under conditions effective to form aluminum oxide.

14. The method of claim 13 wherein prior to applying the tape, the method further comprises cleaning the aluminum surface prior to applying the tape.

15. The method of claim 14 wherein after cleaning and prior to applying the tape, the method further comprises applying a conversion coating on the aluminum surface.
